(19) United States
(12) Patent Application Publication
(10) Pub. No.: US 2005/0202774 A1
(43) Pub. Date: Sep. 15, 2005

(54) Headliner ventilation system with headliner air duct integrated with pillar air duct

(76) Inventor: Clarence P. Lipke, Fenton, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/507,405

(22) PCT Filed: Mar. 11, 2003
(86) PCT No.: PCT/US03/07188

§ 371 Date: May 9, 2005

Related U.S. Application Data
(60) Provisional application No. 60/363,048, filed on Mar. 11, 2002.

(51) Int. Cl. B60H 1/26

(52) U.S. Cl. 454/137

(57) ABSTRACT

A headliner ventilation system that includes a headliner air duct positioned within the headliner along with an integrated pillar air duct for delivering air from a source, such as a heater and/or air conditioner, to the headliner air duct. The pillar air duct is integrally formed with the headliner air duct by use of a flexible hinge portion that allows the pillar air duct to be selectively positioned between a compact shipping state for easy storage and transport of the headliner and an extended state for easy installation into the vehicle. Because the pillar air duct is integrated with the headliner air duct, an adequate seal is ensured between the headliner air duct and the pillar air duct. In addition, less time and inventory are required, thereby reducing labor and expenses.

### BACKGROUND OF THE INVENTION

1. Field of the Invention

This invention is generally related to a headliner ventilation system for a vehicle, and in particular to a headliner ventilation system that includes a headliner air duct with an integrated pillar air duct that can collapse into a compact state for transport and then unfolded into an extended state for installation into a vehicle.

2. Description of the Related Art

Most of today's vehicles have multiple air vents located within them for circulating heated or conditioned air throughout the interior of the vehicle. A typical headliner ventilation system 10 is shown in FIG. 1. Often some of these vents are located in a headliner 11 of the vehicle to allow for more efficient circulation. This location requires a headliner air duct 12 within the headliner 11 along with a second duct 14 for transporting air from an air source 16, such as a heater and/or air conditioner to the headliner air duct 12. This second duct 14 usually is installed within a pillar area of the vehicle. During the assembly process, this pillar air duct 14 must be aligned with and connected to the headliner air duct 12 in such a manner as to assure an adequate seal therebetween. Unfortunately, this adequate seal may not be provided due to human error during the assembly process, resulting in loss of airflow delivery in the ventilation system 10.

### SUMMARY OF THE INVENTION

The invention is directed to a headliner ventilation system, or more specifically, a headliner air duct that has an integrated pillar air duct. The pillar air duct allows delivery of air from an air source, such as a heater and/or air conditioning system of the vehicle, to the headliner air duct. One feature of the invention is that the integrated pillar air duct can be selectively positioned into a compact state allowing for easy transport and storage of the headliner. Another feature of the invention is that during installation the integrated pillar air duct can be selectively positioned from the compact state into an extended state for easy assembly of the headliner ventilation system.

### BRIEF DESCRIPTION OF THE DRAWINGS

In the drawings:

FIG. 1 is a simplified depiction of a typical prior art headliner configuration requiring a separate pillar duct;

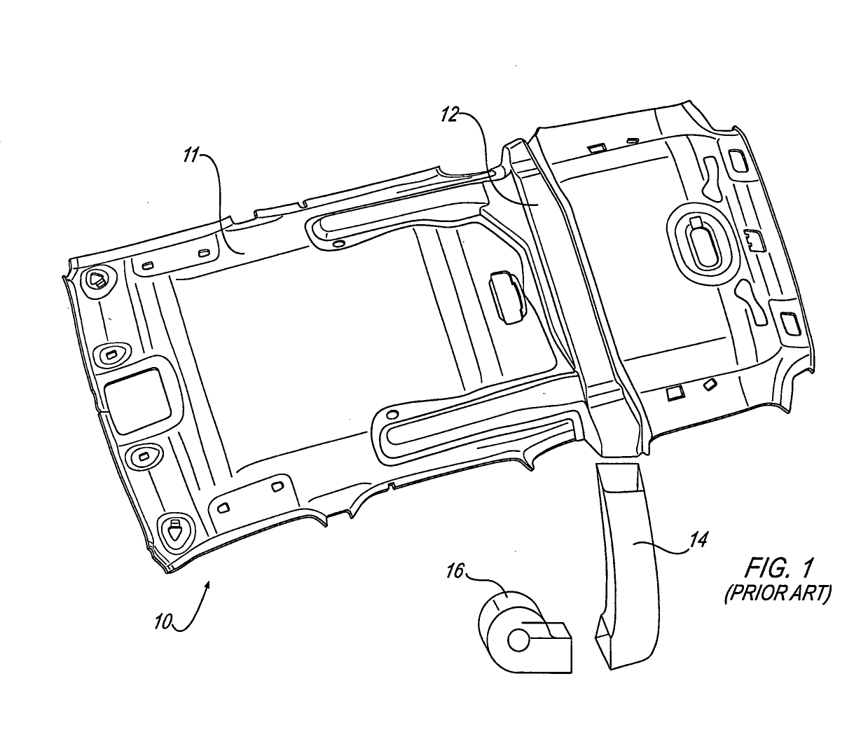

FIG. 2 is a simplified depiction of a headliner with an integrated pillar duct in accordance with the present invention; and

FIG. 3 is a simplified depiction of a headliner with an integrated pillar duct that is folded up into a shipping position for easy transport in accordance with the present invention.

### DESCRIPTION OF THE PREFERRED EMBODIMENT

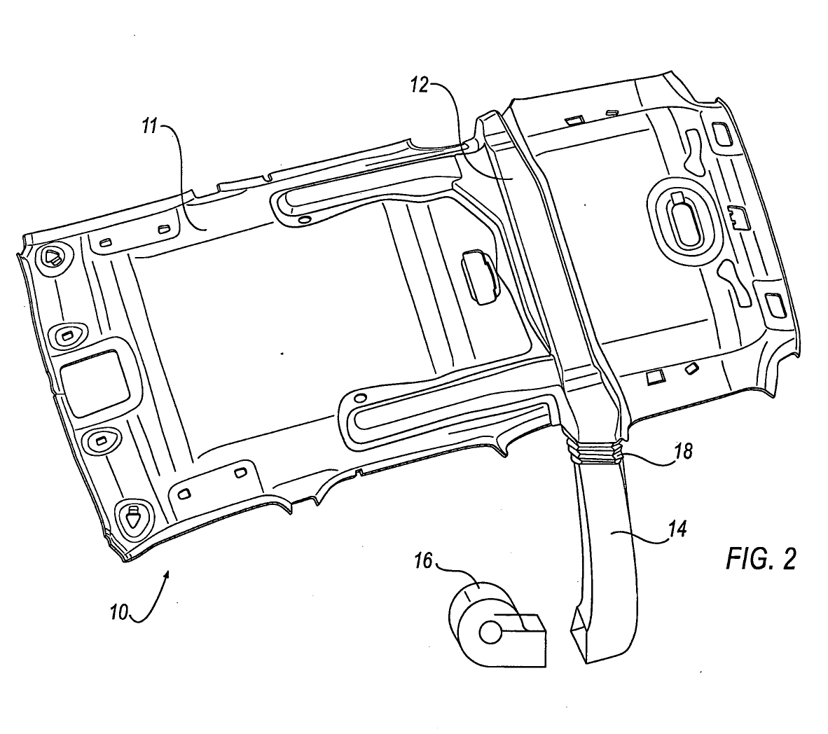

Referring to FIG. 2, a headliner ventilation system, shown generally at 10′ in accordance with the claimed invention, includes a headliner 11, and a headliner air duct 12 that is integrally formed with a pillar air duct 14 by a flexible hinge portion 18 to provide fluid communication therebetween. During assembly of a vehicle interior (not shown), the headliner ventilation system 10′ can be easily mounted and connected to an air source 16 without concern for proper alignment and sealing connection of the pillar air duct 14 with the headliner air duct 12, unlike conventional headliner configurations that require accurate manual alignment of the two separate air ducts to form a proper seal therebetween.

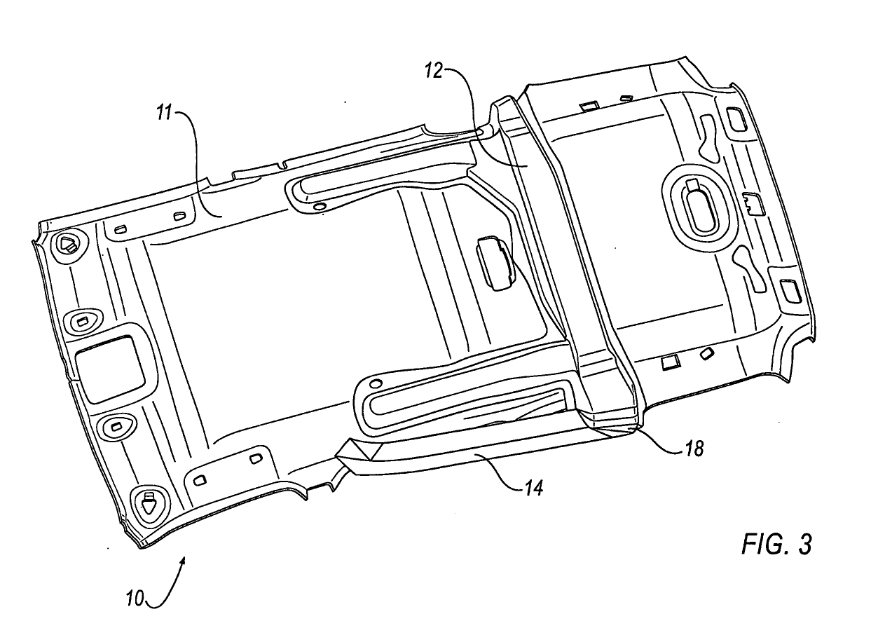

As illustrated in FIG. 3, prior to being incorporated into the vehicle, the flexible hinge portion 18 also allows the headliner ventilation system 10′ to be easily stored or transported by folding the pillar air duct 14 into a compact, shipping position or state. Thus, the flexible hinge portion 18 allows the headliner ventilation system 10′ to be selectively positioned between the compact state for storage or transport and an extended state for installation into the vehicle.

The flexible hinge portion 18 may be any desirable configuration to allow the headliner ventilation system 10′ to be selectively positioned between the compact state and the extended state. Preferably, the flexible hinge portion 18 is optimally designed to allow airflow to travel through the flexible hinge portion 18 with as little noise, vibration and harshness (NVH) as possible. For example, the flexible hinge portion 18 may include a plurality of accordion-like corrugations for reducing NVH.

Unlike conventional headliner ventilation configurations that utilize two duct pieces and require a proper seal to be made between them, the present invention offers several advantages. By integrating the pillar air duct 14 with the headliner air duct 12, fewer components are required, leading to decreased inventory of required parts. Additionally, reduced assembly costs are appreciated due to decreased labor requirements. Lastly, because the two ducts 12, 14 are integrated, there is no concern for air leakage due to an improper seal between the two ducts, unlike conventional headliner ventilation systems in which human error in connecting the two ducts during the assembly process may result in an improper alignment and sealing action between the two ducts.

It will be appreciated that the illustrated embodiment of the invention as described above can be applied to other ventilation systems within a vehicle, such as a ventilation system for a vehicle dashboard, or the like.

While the invention has been specifically described in connection with certain specific embodiments thereof, it is to be understood that this is by way of illustration and not of limitation, and the scope of the appended claims should be construed as broadly as the prior art will permit.

1-3. (canceled)

4. A headliner ventilation system for a vehicle, comprising:
a headliner air duct, and
a pillar air duct integrally formed and in fluid communication with said headliner air duct by use of a flexible hinge portion for selectively positioning said headliner ventilation system between a compact state and an extended state.

5. A headliner ventilation system as claimed in claim 4, wherein said flexible hinge portion includes a plurality of accordion-like corrugations.
